(19) United States
(12) Patent Application Publication
(10) Pub. No.: US 2015/0106154 A1
(43) Pub. Date: Apr. 16, 2015

(54) SYSTEM AND METHOD FOR FINANCIAL RISK ASSESSMENT

(71) Applicant: Actimize Ltd., Ra'anana (IL)

(72) Inventors: Wesley Kenneth Wilhelm, Spokane, WA (US); Chen Ari Kirsch, Tel Aviv (IL)

(73) Assignee: Actimize Ltd., Ra'anana (IL)

(21) Appl. No.: 14/053,791

(22) Filed: Oct. 15, 2013

(51) Int. Cl. G06Q 10/06

(52) U.S. Cl. CPC G06Q 10/0635
USPC 705/7.28

(57) ABSTRACT

A computer-implemented method and system for financial risk assessment are provided. The method includes receiving financial data related to an international monetary transaction from a transferring country to a receiving country; determining a universal currency for the receiving country based on at least one purchasing power parity (PPP) value related to the receiving country; and assessing the financial risk of the international monetary transaction based on the universal currency and the financial data.

### FIELD OF THE INVENTION

The present invention is generally related to risk assessment, and particularly to financial risk assessment.

### BACKGROUND OF THE INVENTION

Advancements in computing and communication technologies have enabled significant changes in the way international financial transactions are made between institutions, businesses, organizations, government agencies and the like. Vast amounts of international financial transactions are conducted world wide on a daily basis. The common practice when conducting a financial transaction between two countries having different currencies is the use of exchange rates.

Some of these international financial transactions may be a result of fraudulent activity. For example, a “fraudster” may use a transaction to transfer money from a legitimate bank account in a first country to an account maintained or owned by the fraudster at a second country. If not blocked before processing, such fraudulent transactions or transfers may cause a direct loss of money.

Detecting fraudulent activity is done by monitoring and detecting abnormal financial activity levels. When assessing a risk associated with an international financial transaction, one of the parameters currently in use is the amount of money involved in the transaction. Threshold values (e.g., USD 1000) are set for various international financial activities and every transaction or activity that involves sums of money higher than the threshold is to be inspected. The current systems and methods do not take into account the difference in the purchasing power between countries, for example, a sum of EURO 100 in Germany does not have the same purchasing power as EURO 100 in India. Therefore, an international transaction of EURO 100 to Germany is not considered to be a “risky” or unsafe transaction, however, a transaction of EURO 100 to India, may have to be inspected as a suspicious or risky transaction. One way to measure and calculate the differences in purchasing power between countries and markets is the use of a purchasing power parity (PPP) value. There are several known PPP values, for example, Organization for Economic Co-operation and Development (OECD) comparative price levels, the World Bank PPP database and even the Big Mac Index.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a diagrammatic representation of a financial transaction flow according to embodiments of the invention;

FIG. 2 shows a method of financial risk assessment according to embodiments of the invention;

FIG. 3 shows a method of financial risk assessment according to embodiments of the invention;

FIG. 4 shows a method of determining a universal currency according to embodiments of the invention; and

FIG. 5 shows a high level block diagram of an exemplary computing device according to some embodiments of the present invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

Embodiments of the present invention may be related to a system and method for risk assessment of international financial transactions that take into account the difference in purchasing power at the various markets (e.g., countries) participating in a certain financial transaction. Currently, when assessing the risk associated with the amount of money involved in an international financial transaction, the purchasing power of the destination country is not taken into account. Currently used methods only set a threshold value or values (for example, USD 1000), and any international transaction at any currency is converted to USD and compared to the threshold value. A transaction below the threshold value is not being inspected and a transaction equal or above the threshold value is being inspected for being a potentially risky transaction. Some risk assessment methods includes additionally or alternatively to the threshold factor, other factors (e.g., risk factors), such as historical records related to international transactions performed by one or more of the parties participating in the transaction. Additional risk assessing factors may be related to social media information (e.g., Facebook, LinkedIn, or the like) related to one or more of the parties participating in the transaction.

In some destination markets, however, the universal threshold value may be too high because of a high purchasing power which enables purchasing large amount of goods and commodities (relative to a country were the same amount of money has a lower purchasing power). For example, in the USA an amount of UDS 100 has a limited purchasing power, thus an international transaction of USD 100 to the USA may not be considered a risky transaction, however, an international transaction of USD 100 to Malaysia may have to be considered a risky transaction since the purchasing power of USD 100 in Malaysia is much higher than in the USA.

The standard financial instrument that is currently in use to convert one currency to another and compare the amounts of financial transactions is the foreign-exchange rate. Most exchange rates between different currencies are determined by the retail currency exchange market. Some embodiments of the invention may be related to determining, calculating, setting or defining a “universal currency” that take into account the purchasing power of the destination or the receiving country. As used herein, a universal currency of a particular country is referred to any value equal to, or calculated from one or more known PPP values. The universal currency may be given in real currency units (e.g., USD, EURO, YEN), a mathematical operation of a real currency (e.g., 1/USD, EURO²) or not having any units. Using the new financial instrument, the universal currency, may be useful in detecting risky transactions more accurately.

In some embodiments, the universal currency may be determined by using any known purchasing power parity (PPP) value. For example, the World Bank publishes annual PPP values for every country, with respect to the USD. In 2011, the World Bank PPP value for Nicaragua was 0.4 with respect to the USD. Therefore, USD 500 in Nicaragua has a purchasing power of 500/0.4=1250 USD in the USA. The universal currency of Nicaragua using the World Bank PPP value with respect to the USD is 2.5. In some embodiments, more than one PPP value from more than one origin may be considered when calculating a universal currency.

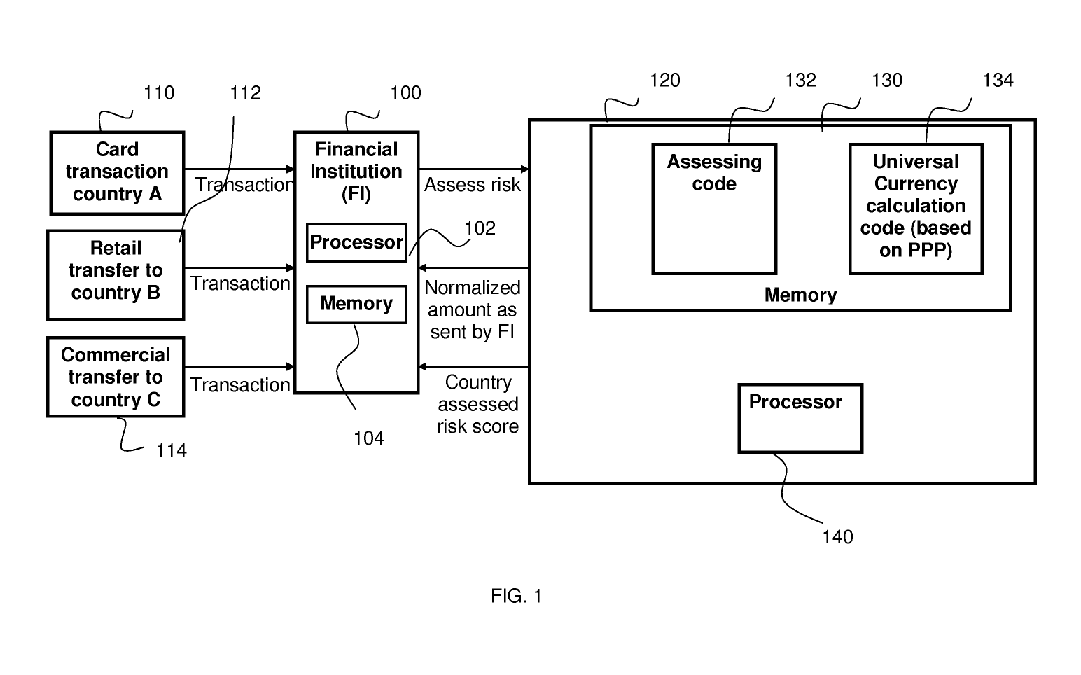

Referring now to FIG. 1, which shows a financial transaction flow and analysis routine according to some embodiments of the invention. A financial institution (FI) 100 may receive a request for various types of international transactions from various sources, for example, a credit card transaction from a first country 110, a retail transfer to a second country 112 and a commercial transfer to a third country 114. The financial institution may include a computation platform comprising a processor 102 configured to receive and transmit financial transactions and a memory 104. The transactions may be processed by a system 120 for risk assessment of international transactions. System 120 may include a memory 130 storing an assessing code 132 and a universal currency calculation code 134, and a processor 140 for executing the codes.

As used herein, financial institutions may refer to any entity that may be involved in an international financial transaction. Non-limiting examples of such entities may include, banks, credit unions, trust companies, government agencies, international intuitions (e.g., UN agencies, European Community agencies etc.), or the like. It should be understood, however, to a person skilled in the art that embodiments of the invention are not limited in that respect and the scope of the invention includes international transaction between companies, non-profit organizations and others.

Processor 102 may be any computing platform, for example, a central processing unit processor (CPU), a chip or any suitable computing or computational device. The processor may further receive analysis and/or assessment reports of the risk associated with financial transactions executed by financial institution 100. The processor may be configured to block a potentially risky transaction or conduct additional analysis of such potentially risky transactions. Memory 104 may include codes and instructions to be executed by processor 102, for example receiving and/or transferring money to or from various destinations. Memory 104 may include non-transitory readable medium and/or non-transitory storage medium, such as for example a memory, a disk drive, or a USB flash memory for storing instructions, e.g., computer-executable instructions, which, when executed by a processor (e.g., processor 102), carry out methods disclosed herein.

Processor 102 of financial institution 100 may receive various types of transactions from various countries, for example, credit card transaction 110 to/from country A; retail transfer 112 to country B and/or commercial transfer 114 to/from country C. Each of the financial transactions may be analyzed by system 120 for risk assessment of the transaction. A request may be sent from processor 102 to system 120 to assess the risk of a particular financial transaction, for example, retail transfer 112.

The request may be received by processor 140 of system 120. Processor 140 may be any computing platform, for example, a central processing unit processor (CPU), a chip or any suitable computing or computational device. Memory 130 may be any article comprising non-transitory readable medium and/or non-transitory storage medium, such as for example, a memory, a disk drive, or a USB flash memory for storing instructions, such as the instructions included in codes 132 and 134, that when unexecuted may cause processor 140 to determine a universal currency and assess the financial risk of an international transaction. In some embodiments, codes 132 and 134 may be included in a single code.

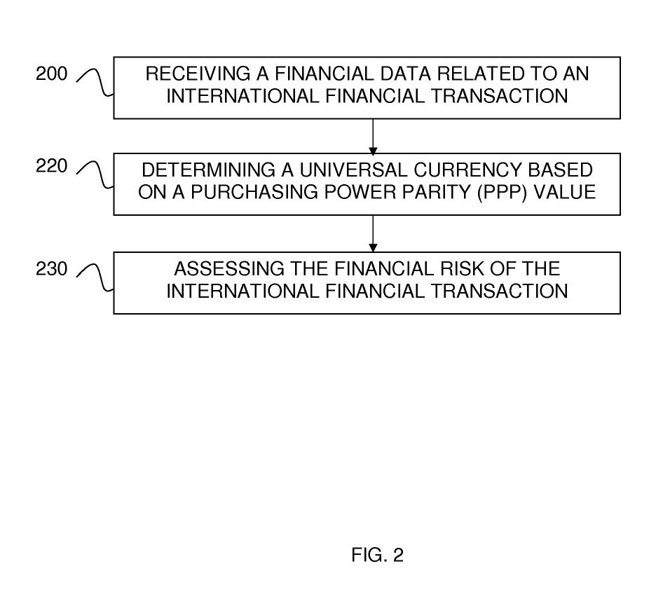

Reference is made to FIG. 2, showing a flowchart of a method of financial risk assessment according to some embodiments of the invention. The method may be performed by a processor included in a system for assessing financial risk (e.g., processor 140 included in system 120) and/or may be stored on an article comprising a non-transitory computer-readable storage medium (e.g., memory 130), having stored thereon instructions, that when executed on a computer, causes the computer to execute the method. In operation 200, the method may include receiving financial data related to an international monetary transaction from a transferring country to a receiving country. The financial data may be received from any entity or financial institution (e.g., financial institution 100), such as banks, insurance companies or from any other institution that is involved in financial transactions (e.g., government agencies and enterprises). The financial data may include any data related to the transaction, for example, the amount of money to be transferred, account numbers in the transferring country and the receiving country, the exchange rates between the two countries, or the like. In some embodiments, the international transaction may involve transactions from more than one transferring country to one or more receiving countries, all involved in a single related monetary transaction. The financial data may be stored at any data storage unit that is accessible to the processor (i.e. the computer) executing the method.

In operation 220, the method may include determining a universal currency for the receiving country based on purchasing power parity (PPP) value related to the receiving country. The PPP value may be received from any financial institution (FI) or any source that calculates PPP values for various countries, for example, the United Nation (UN) database, the World Trade Association (WTA) database, the International Monetary Fund (IMF) data base, the OECD database, the World Bank database, or others. PPP values are usually calculated with respect to a base currency (e.g., USD, EURO or YEN) or to a known a mount of money (e.g., the Big Mac index). The PPP values for various countries may be stored at any data storage unit that is accessible to the processor (e.g., processor 140) executing the method. The PPP values may change annually due to changes in local and world markets, and therefore the PPP values may be updated at least once a year. Table 1 presents examples taken from the World Bank website for PPP values (relative to one USD) for several countries from the years 2008-2011. As shown in Table 1 below, the purchasing power of various countries varies during the year, some economies grow (e.g., Brazil, Angola) and some decline (e.g., the United Kingdom).

TABLE 1

| Country | 2008 | 2009 | 2010 | 2011 |
|---|---|---|---|---|
| USA | 1 | 1 | 1 | 1 |
| Albania | 0.5 | 0.4 | 0.4 | 0.5 |
| Angola | 0.8 | 0.6 | 0.7 | 0.9 |
| Brazil | 0.8 | 0.8 | 1.0 | 1.1 |
| Canada | 1.2 | 1.0 | 1.2 | 1.2 |
| Germany | 1.2 | 1.1 | 1.1 | 1.1 |
| Israel | 1.1 | 1.0 | 1.1 | 1.1 |
| India | 0.4 | 0.4 | 0.4 | 0.4 |
| Norway | 1.6 | 1.4 | 1.5 | 1.6 |
| Switzerland | 1.4 | 1.4 | 1.4 | 1.6 |
| United Kingdom | 1.2 | 1.0 | 1.0 | 1.1 |

The system may include a code 134 for calculating the universal currency. For example, if the receiving country is Switzerland a universal currency may be determined based on the PPP value of Switzerland (e.g., 1.6 comparing to 1/USD in 2011). The universal currency of Switzerland may be 1/USD 1.6 or 1/1.6=USD 0.625 or any other calculation based on the PPP value 1.6. The universal currency may be determined with respect to the base currency from which the PPP value was calculated.

In operation 230, the method may include assessing the financial risk of the international monetary transaction based on the universal currency and the financial data. A universal value related to an amount of money involved in the international monetary transaction, may be determined using the universal currency and the financial data related to the international monetary transaction. For example, the amount of money to be transferred or the amounts of money to be transferred may be converted to the base currency (e.g., USD) from which the universal currency was determined followed by a calculation (e.g., multiplication or an additional conversion) of the amount(s) in the universal currency units. For example, when the amount EURO 1000 is to be transferred to Switzerland, the EURO 1000 may be converted to USD 1345 and the universal value related to the amount of money involves in the international monetary transaction may be 1345*0.625=USD 840.625, wherein USD may be used as the universal currency units. The system (e.g., system 120) may include a code 132 that assesses if a transaction of USD 840.625 is a potentially risky transaction.

In some embodiments, assessing the financial risk of the international monetary transaction is according to a rule or set of rules which are associated with the universal currency. After assessing that an international transaction is a risky transaction, processor 140 may alert a user, via a user interface, or may alert processor 102 that the transaction is potentially risky and should be either stopped or sent for further assessment.

In some embodiments, additional risk factors may be included in the financial risk assessing method. Risk factors calculated based on historical records and data related to one or more of the parties participating in the transaction may be taken into account in determining if an international financial transaction is risky or not. An example of such a risk factor may be related to historical records of international transactions performed by one or more of the parties participating in the transaction (e.g., amounts of money that were involve, problems that occurred during or after the historical transactions or the like). Additional risk assessing factors may be based on data gathered from social media (e.g., Facebook, LinkedIn, or the like) related to one or more of the parties participating in the transaction. System and methods for determining risk factors are disclosed in U.S. patent application Ser. No. 13/605,142, Filed Sep. 9, 2012 and U.S. patent application Ser. No. 13/467,412, filed May 9, 2013 that are assigned to the common assignee of the present application and incorporated herein by reference in their entirety

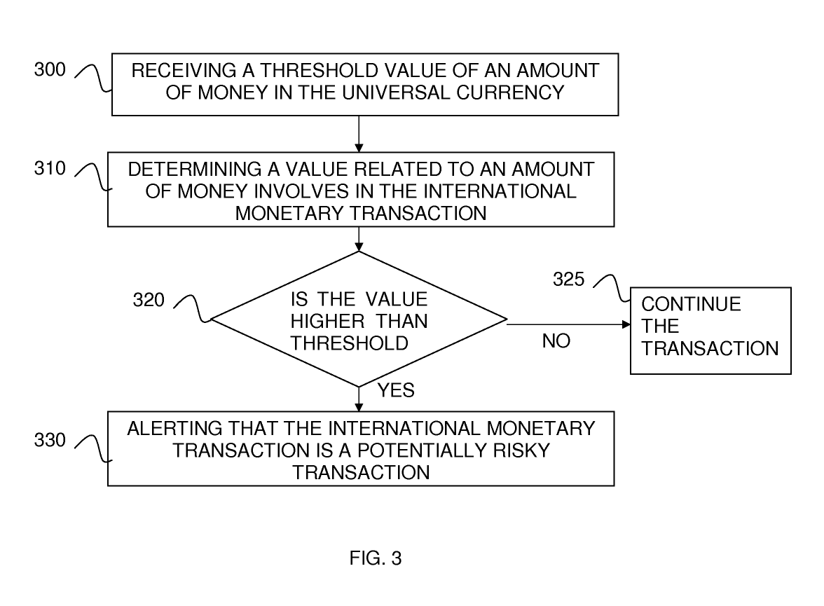

FIG. 3 shows a method for assessing the financial risk of financial transactions according to some embodiments of the invention. The method may be included in risk assessing code 132. In operation 300, the method may include receiving a threshold value of an amount of money presented in the universal currency units, for example the universal currency determined in operation 220 of FIG. 2. The threshold value may be received from a storage unit associated with a processor, for example, processor 140, or may be received from a user via a user interface. In some embodiments, if the universal currency was determined with respect to the EURO, the threshold value may be EURO 2000. Any amount of money to be transferred that is equal or above the threshold value, may be assessed as a potentially risky transaction.

In operation 310, the method may further include determining a universal value related to an amount of money involved in the international monetary transaction based on the universal currency and the financial data related to an international monetary transaction. For example, processor 140 may receive from processor 102 an amount of money to be transferred to country B, in EURO (e.g., EURO 1200), processor 140 may determine a universal value related to the amount of transferred money, for example, the amount of money may be multiplied by the universal currency determined based on a PPP value of country B. If the universal currency of country B with respect to the EURO is 1.8, the universal value related to the amount of transferred money is 1.8*1200=EURO 2160.

In operation 320, the method may include comparing the determined universal value related to the amount of money involved in the international monetary transaction with the threshold value. If the universal value related to the amount of money involved in the international monetary transaction is below the threshold value, e.g., lower than 2000 EURO, processor 140 may instruct processor 102 to continue with the transaction, in operation 325. If the universal value related to the amount of money to be transferred is equal or above the 2000 EURO that was set as threshold in operation 300, for example, the 2160 EURO calculated in the example of operation 310, the method may include alerting a user that the international monetary transaction may be a potentially risky transaction. Processor 140 may alert processor 102 that a particular transaction is potentially risky transaction. Alternatively, processor 102 may assess the risk of the particular transaction based on the universal value related to the amount of money and the threshold value. Processor 102 or processor 140 may alert a user about the potentially risky transaction via a user interface.

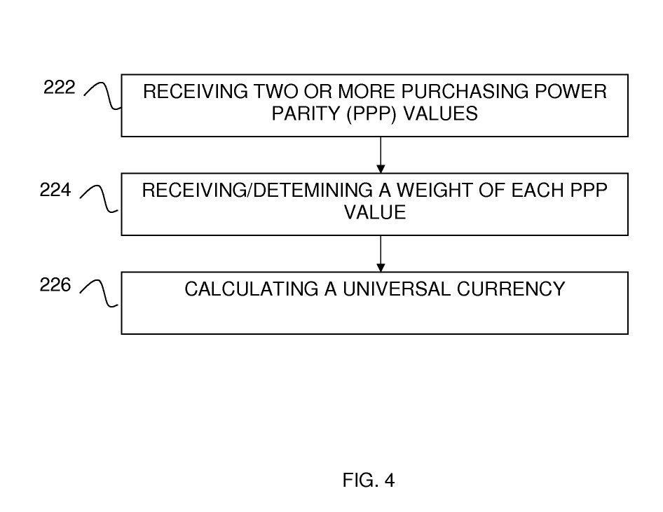

Reference is made to FIG. 4 that shows a method of determining a universal currency according to some embodiments of the invention. In operation 222, the method may include receiving two or more PPP values, from two or more sources, each related to the receiving countries. For example, a PPP value for a particular country for the present year may be received from data published by the World Bank, the Big Mac index, data published by the OECD or the like. In operation 224, the method may include receiving or determining monetary weight for each of the PPP value sources. The monetary weight may be received from data stored in a storage unit associated with the processor (e.g., processor 140) or may be received from a user via user interface. In some embodiments, the monetary weight may be determined, by a processor using a code, based for example on accuracy or reliability rating of the PPP source. For example, the World Bank may be considered as a reliable source for PPP values, thus the PPP values received from the World Bank may receive higher monetary weights in comparison to other PPP value sources.

In operation 226, the method may include calculating a universal currency based on the PPP values received from various sources. An exemplary method for calculating the universal currency may include receiving from N sources PPP values related to M countries and determine monetary weights (W's) for each source, as presented in table 2. For each country the PPPᵢⱼ received from a particular source is multiply by Wⱼ the monetary weight of the source, wherein the total some of the monetary weights for each country may be equal to one

$${\sum }_{1 - N}^{j} {W}_{j} = 1.$$

TABLE 2

| | PPP | PPP | PPP | PPP |
|---|---|---|---|---|
| | source 1 | source 2 | source (j) | source N |
| Country 1 | W₁*PPP₁₁ | W₂*PPP₁₂ | Wⱼ*PPP₁ⱼ | W_{N}*PPP_{1N} |
| Country 2 | W₁*PPP₂₁ | W₂*PPP₂₂ | Wⱼ*PPP₂ⱼ | W_{N}*PPP_{2N} |
| Country (i) | W₁*PPPᵢ₁ | W₂*PPPᵢ₂ | Wⱼ*PPPᵢⱼ | W_{N}*PPP_{iN} |
| Country M | W_{M}*PPP_{M1} | W₂*PPP_{M2} | Wᵢ*PPP_{Mj} | W_{N}*PPP_{MN} |

The universal currency for a country i (UCᵢ) may be calculated using the equation (1).

$${UC}_{i} = {\sum }_{1 - N}^{j} {W}_{j} {PPP}_{ij} \qquad ( 1 )$$

In some embodiments, the monetary weight for each source may also be country dependant and may vary from country to country. For example, the reliably of a source may be better for a first country than for a second country, thus the monetary weight given to this source for the first country may be higher than for the second country. For example, when the source is the data published by the OECD, the reliably of data related to an OECD country may be higher than the reliably of data related to a non OECD country.

In some embodiments, the monetary weight may be determined based on the strength of historical reliability, for example, by evaluating the source over time against a baseline (e.g., a baseline determined by a user) and assigning each source using a monetary weighted percentage between 0 and 1 that indicates the source's accuracy. In yet another example, the monetary weight may be determined based on the academic prestige of the source, e.g., how long the source has been publishing PPP values and/or how often it is quoted or referenced in academic papers. In some embodiments, a Champion or a Challenger or a Champion Challenger process or a modified Champion Challenger (i.e., when more than one challenger running in the same time) process comprising the step of Contender may be used to determine the monetary weight of each source. In some embodiments, at least two methods are used to evaluate if a financial transaction is “risky” or not, for example, a first method that includes determining a universal currency (e.g., the method of FIG. 2) and a second method that relates to historical financial records of one or more of the parties involve. One of the methods, the champion, may be considered to be “the more reliable” method and may be used to assess the risk of 90% of the transactions. The other method, “the challenger” may be used to assess the risk in the remaining 10%. A continuous evaluation of the two methods is done and if the challenger method is found to give better assessment, the challenger becomes the champion and vise versa. In some embodiments, there is more than one challenger.

The following is a numerical example for calculating a universal currency for Malaysia using data received from two sources. Table 3 presents PPP values (relative to one USD) and relative monetary weights received from sources 1 and 2, for Malaysia, Israel, Switzerland and the United Kingdom.

TABLE 3

| Country | Source 1. | Source 2. |
|---|---|---|
| Malaysia | PPP_{MY} 2.0 Weight 0.8 | PPP_{MY} 1.5. Weight 0.2 |
| Israel | PPP_{IL} 3.588. Weight 0.7 | PPP_{IL} 3.22. Weight 0.3 |
| Switzerland | PPP_{CH} 0.78. Weight 0.65 | PPP_{CH} 0.75. Weight 0.35 |
| United Kingdom | PPP_{UK} 0.65. Weight 0.8 | PPP_{UK} 0.68. Weight 0.2 |

As can be seen from Table 3, source 1 has a higher monetary weight due to better reliability. However, source 1 is better in predicting the PPP values of Malaysia and the United Kingdom, than predicting the PPP values of Switzerland and Israel, thus the monetary weight of source 1 for Switzerland and Israel is lower than for Malaysia and the United Kingdom.

The universal currency of Malaysia may be calculated using equation (1)

UC_{MY}=0.8*2.0+0.2*1.5=1.9 (1)

The determined universal currency may be multiplied with the actual amount of money to be transferred to Malaysia in a particular financial transaction. For example, when USD 5000 is to be transferred to Malaysia the risk assessment of this amount should take into account the amount as 5000*1.9=9000 USD, taking into consideration the purchasing power in Malaysia.

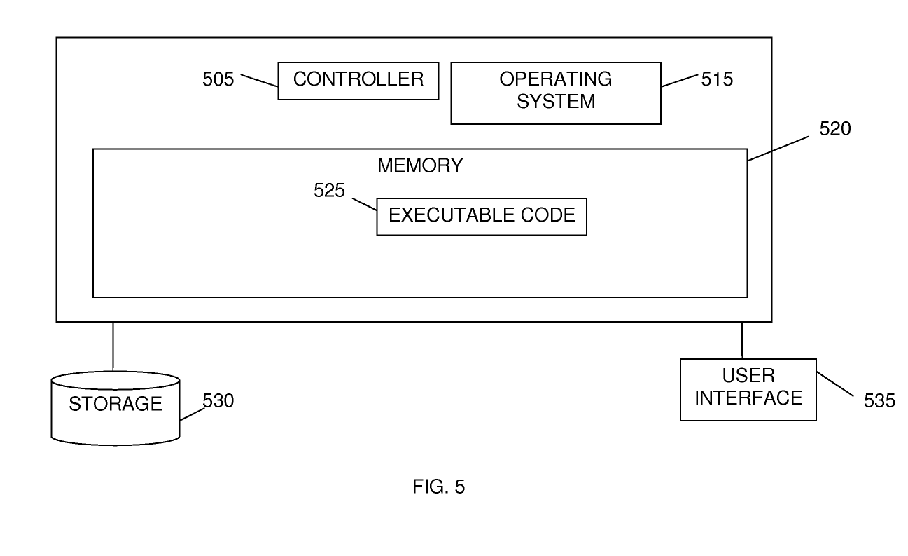

Reference is made to FIG. 5, showing high level block diagram of an exemplary computing device according to some embodiments of the present invention. Computing device 500 may include a processor 505 that may be, for example, a central processing unit processor (CPU), a chip or any suitable computing or computational device, an operating system 515, a memory 520, storage 530, and a user interface 535. Computing device 500 may be included in system 120 for risk assessment of international transactions.

Operating system 515 may be or may include any code segment designed and/or configured to perform tasks involving coordination, scheduling, arbitration, supervising, controlling or otherwise managing operation of computing device 500, for example, scheduling execution of programs. Operating system 515 may be a commercial operating system. Memory 520 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 520 may be or may include a plurality of, possibly different memory units.

Executable code 525 may be any executable code, e.g., an application, a program, a process, task or script. Executable code 525 may include codes for assessing risks in international transactions and/or calculating a universal currency. Executable code 525 may be executed by processor 505 possibly under control of operating system 515. For example, executable code 525 may include assessing code 132 and universal currency calculation code 134 and may cause processor 505 to receive financial data related to an international financial transaction; receive PPP value(s); determine universal currency and assess the risk of the international financial transaction based on the determined universal currency.

Storage 530 may be or may include, for example, a hard disk drive, a floppy disk drive, a Compact Disk (CD) drive, a CD-Recordable (CD-R) drive, a universal serial bus (USB) device or other suitable removable and/or fixed storage unit. Content may be stored in storage 530 and may be loaded from storage 530 into memory 520 where it may be processed by controller 505. For example, storage 530 may include data related to international financial transaction, PPP values related to various countries received from various sources and/or monetary weights related to each of the PPP values.

User Interface 535 may be or may include input devices such as, a mouse, a keyboard, a touch screen or pad or any suitable input device. It will be recognized that any suitable number of input devices may be included in user interface 535. User interface 535 may further include output devices such as: one or more displays, speakers and/or any other suitable output devices. It will be recognized that any suitable number of output devices may be included in user interface 535. Any applicable input/output (I/O) devices may be connected to computing device 700 as shown by block 535. For example, a wired or wireless network interface card (NIC), a modem, printer or facsimile machine, a universal serial bus (USB) device or external hard drive may be included in user interface 535.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, a storage medium such as memory 520, computer-executable instructions such as executable code 525 and a controller such as controller 505.

Some embodiments may be provided in a computer program product that may include a non-transitory machine-readable medium, stored thereon instructions, which may be used to program a computer, or other programmable devices, to perform methods as disclosed herein. Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein. The storage medium may include, but is not limited to, any type of disk including floppy disks, optical disks, compact disk read-only memories (CD-ROMs), rewritable compact disk (CD-RWs), and magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

A system according to embodiments of the invention may include components such as, but not limited to, a plurality of central processing units (CPU) or any other suitable multi-purpose or specific processors or controllers, a plurality of input units, a plurality of output units, a plurality of memory units, and a plurality of storage units. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a tablet computer, a network device, or any other suitable computing device. Unless explicitly stated, the method embodiments described herein are not constrained to a particular order or sequence. Additionally, some of the described method embodiments or elements thereof can occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A computer-implemented method for financial risk assessment comprising:
receiving financial data related to an international monetary transaction from a transferring country to a receiving country;
determining a universal currency for the receiving country based on at least one purchasing power parity (PPP) value related to the receiving country; and
assessing the financial risk of the international monetary transaction based on the universal currency and the financial data.

2. The method of claim 1, wherein assessing the financial risk of the international monetary transaction is according to a predefined rule.

3. The method of claim 1, further comprising:
determining a universal value related to an amount of money involved in the international monetary transaction based on the universal currency, the universal value is defined in universal currency units; and
issuing an alert indicating that the international monetary transaction is a potentially risky transaction if the universal value is above a threshold value.

4. The method of claim 1, wherein the universal currency is based on two or more PPP values related to the receiving country and the method further comprises:
receiving monetary weights, each associated with one of the PPP values; and
calculating the universal currency based on the PPP values and the monetary weights.

5. The method of claim 1, wherein the universal currency is based on two or more PPP values related to the receiving country and the method further comprises:
determining monetary weights, each associated with one of the PPP values; and
calculating the universal currency based on the PPP values and the weights.

6. The method of claim 1, wherein the financial data is received from a financial institution.

7. The method of claim 1, wherein assessing the financial risk is done during the international monetary transaction.

8. A system for assessing a financial risk comprising:
a processor configured to:
receive financial data related to an international monetary transaction from a transferring country to a receiving country;
determine a universal currency for the receiving country based on at least one purchasing power parity (PPP) value related to the receiving country; and
assess the financial risk of the international monetary transaction based on the universal currency and the financial data;
and
a memory configured to store instructions associated with assessment of the financial risk of the international monetary transactions.

9. The system of claim 8, further comprising: at least one storage unit for storing the at least one PPP value.

10. The system of claim 8, wherein the financial risk of the international monetary transaction is assessed according to at least one rule stored in the memory.

11. The system of claim 8, wherein the processor is further configured to determine a universal value related to an amount of money involved in the international monetary transaction, the universal value is defined in universal currency units and to issue an alert indicating that the international monetary transaction is a potentially risky transaction if the universal value is above a threshold value.

12. An article comprising a non-transitory computer-readable storage medium, having instructions stored thereon that when executed by a processor, cause the processor to:
receive financial data related to an international monetary transaction from a transferring country to a receiving country;
determine a universal currency for the receiving country based on at least one purchasing power parity (PPP) value related to the receiving country; and
assess the financial risk of the international monetary transaction based on the universal currency and the financial data.

13. The article of claim 12, wherein the instructions when executed further cause the processor to:
determine a universal value related to an amount of money involved in the international monetary transaction, the universal value is defined in universal currency units; and
issue an alert indicating that the international monetary transaction is a potentially risky transaction if the universal value is above a threshold value.

14. The article of claim 11, wherein the universal currency is based on two or more PPP values related to the receiving country and the instructions when executed further cause the processor to:
receive monetary weights, each associated with one of the PPP values; and
calculate the universal currency based on the PPP values and the monetary weights.

15. The article of claim 11, wherein the universal currency is based on two or more PPP values related to the receiving country and the instructions when executed further cause the processor to:
determine monetary weights, each associated with one of the PPP values; and
calculate the universal currency based on the PPP values and the monetary weights.
